(19) United States
(12) Patent Application Publication
(10) Pub. No.: US 2006/0088102 A1
(43) Pub. Date: Apr. 27, 2006

(54) Method and apparatus for effectively encoding multi-layered motion vectors

(75) Inventors: Kyo-hyuk Lee, Seoul (KR); Sang-chang Cha, Hwaseong-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/254,642

(22) Filed: Oct. 21, 2005

Related U.S. Application Data
(60) Provisional application No. 60/620,328, filed on Oct. 21, 2004.
(60) Provisional application No. 60/641,750, filed on Jan. 7, 2005.
(60) Provisional application No. 60/643,127, filed on Jan. 12, 2005.

(30) Foreign Application Priority Data
Dec. 8, 2004 (KR) 10-2004-0103059
Feb. 26, 2005 (KR) 10-2005-0016269

(51) Int. Cl. H04N 11/02; H04N 7/12; H04N 11/04; H04B 1/66

(52) U.S. Cl. 375/240.16; 375/240.08; 375/240.24

(57) ABSTRACT

An apparatus and method for improving the compression efficiency of a motion vector by efficiently predicting a motion vector in an enhanced layer from a motion vector in a base layer in a video coding method using a multi-layer structure are provided. The method includes obtaining a motion vector in a mother frame of a base layer that is temporally closest to an unsynchronized frame of a current layer, obtaining a predicted motion vector from the motion vector in the mother frame considering the referencing direction in the mother frame and in the unsynchronized frame and distances between the mother frame and a reference frame and between the unsynchronized frame and a reference frame, generating a residual between the motion vector in the unsynchronized frame and the predicted motion vector, and encoding the motion vector in the mother frame and the residual.

### CROSS-REFERENCE TO RELATED APPLICATION

This application claims priority from Korean Patent Application Nos. 10-2004-0103059 and 10-2005-0016269, filed on Dec. 8, 2004 and Feb. 26, 2005, respectively, and U.S. Provisional Patent Application Nos. 60/620,328, 60/641,750 and 60/643,127, filed on Oct. 21, 2004, Jan. 7, 2005 and Jan. 12, 2005, respectively, the whole disclosures of which are hereby incorporated herein by reference.

### BACKGROUND OF THE INVENTION

1. Field of the Invention

Apparatuses and methods consistent with the present invention relate to video compression, and more particularly, to improving the compression efficiency of a motion vector by efficiently predicting a motion vector in an enhanced layer from a motion vector in a base layer in a video coding method using a multi-layer structure.

2. Description of the Related Art

With the development of information communication technology, including the Internet, video communication as well as text and voice communication, has increased dramatically. Conventional text communication cannot satisfy users' various demands, and thus, multimedia services that can provide various types of information such as text, pictures, and music have increased. However, multimedia data requires a storage media that have a large capacity and a wide bandwidth for transmission since the amount of multimedia data is usually large. Accordingly, a compression coding method is requisite for transmitting multimedia data including text, video, and audio.

A basic principle of data compression is removing data redundancy. Data can be compressed by removing spatial redundancy in which the same color or object is repeated in an image, temporal redundancy in which there is little change between adjacent frames in a moving image or the same sound is repeated in audio, or mental visual redundancy which takes into account human eyesight and its limited perception of high frequency. In general video coding, temporal redundancy is removed by motion compensation based on motion estimation and compensation, and spatial redundancy is removed by transform coding.

To transmit multimedia generated after removing data redundancy, transmission media are necessary. Transmission performance is different depending on transmission media. Currently used transmission media have various transmission rates. For example, an ultrahigh-speed communication network can transmit data of several tens of megabits per second while a mobile communication network has a transmission rate of 384 kilobits per second. Accordingly, to support transmission media having various speeds or to transmit multimedia at a data rate suitable to a transmission environment, data coding methods having scalability, such as wavelet video coding and subband video coding, may be suitable to a multimedia environment.

Scalable video coding is a technique that allows a compressed bitstream to be decoded at different resolutions, frame rates, and signal-to-noise ratio (SNR) levels by truncating a portion of the bitstream according to ambient conditions such as transmission bit rates, error rates, and system resources. MPEG-4 (Motion Picture Experts Group 4) Part 10 standardization for scalable video coding is under way. In particular, much effort is being made to implement scalability based on a multi-layered structure. For example, a bitstream may consist of multiple layers, i.e., base layer and first and second enhanced layers with different resolutions (QCIF, CIF, and 2CIF) or frame rates.

Like when a video is encoded into a singe layer, when a video is encoded into multiple layers, motion vector (MV) is obtained for each of the multiple layers to remove temporal redundancy. The motion vector MV may be separately searched for each layer (former approach) or a motion vector obtained by a motion vector search for one layer is used for another layer (without or after being upsampled/downsampled) (latter approach). The former approach has the advantage of obtaining accurate motion vectors while suffering from overhead due to motion vectors generated for each layer. Thus, it is a very challenging task to efficiently redundancy between motion vectors for each layer.

FIG. 1 shows an example of a scalable video codec using a multi-layered structure. Referring to FIG. 1, a base layer has a quarter common intermediate format (QCIF) resolution and a frame rate of 15 Hz, a first enhanced layer has a common intermediate format (CIF) resolution and a frame rate of 30 Hz, and a second enhanced layer has a standard definition (SD) resolution and a frame rate of 60 Hz. For example, to obtain a stream having a CIF resolution and a bit rate of 0.5 Mbps, the enhanced layer bitstream having a CIF resolution, a frame rate of 30 Hz and a bit rate of 0.7 Mbps may be truncated to meet the bit rate of 0.5 Mbps. In this way, it is possible to implement spatial, temporal, and SNR scalabilities. Because about twice as much overhead as that generated for a singe-layer bitstream occurs due to an increase in the number of motion vectors as shown in FIG. 1, motion prediction from the base layer is very important. Of course, since the motion vector is used only for an inter-macroblock encoded using temporally neighboring frames as a reference, it is not used for an intra-macroblock encoded without reference to adjacent frames.

As shown in FIG. 1, frames 10, 20, and 30 in the respective layers having the same temporal position can be estimated to have similar images thus similar motion vectors. Thus, one proposed method for efficiently representing a motion vector includes predicting a motion vector for a current layer from a motion vector for a lower layer and encoding a difference between the predicted value and the actual motion vector.

FIG. 2 is a diagram for explaining a method for efficiently representing a motion vector using motion prediction. Referring to FIG. 2, a motion vector in a lower layer having the temporal position as a current layer is used as a predicted motion vector for a current layer motion vector.

An encoder obtains motion vectors MV₀, MV₁, and MV₂ for a base layer, a first enhanced layer, and a second enhanced layer at predetermined accuracies and performs temporal transformation using the motion vectors MV₀, MV₁, and MV₂ to remove temporal redundancies in the respective layers. However, the encoder sends the base layer motion vector MV₀, a first enhanced layer motion vector component D₁, and a second enhanced layer motion vector component D₂ to the predecoder (or video stream server). The predecoder may transmit only the base layer motion vector, the base layer motion vector and the first enhanced layer motion vector component D₁, or the base layer motion vector, the first enhanced layer motion vector component D₁ and the second enhanced layer motion vector component D₂ to a decoder to adapt to network situations.

The decoder then uses the received data to reconstruct a motion vector for an appropriate layer. For example, when the decoder receives the base layer motion vector and the first enhanced layer motion vector component D₁, the first enhanced layer motion vector component D₁ is added to the base layer motion vector MV₀ in order to reconstruct the first enhanced layer motion vector MV₁. The reconstructed motion vector MV₁ is used to reconstruct texture data for the first enhanced layer.

However, when the current layer has a different frame rate than the lower layer as shown in FIG. 1, a lower layer frame having the same temporal position as the current frame may not exist. For example, because a layer frame lower than a frame 40 is not present, motion prediction through a lower layer motion vector cannot be performed. That is, since a motion vector in the frame 40 cannot be predicted, a motion vector in the first enhanced layer is inefficiently represented as a redundant motion vector.

### SUMMARY OF THE INVENTION

The present invention provides an apparatus and method for efficiently predicting a motion vector in an enhanced layer from a motion vector in a base layer.

The present invention also provides a method for predicting a motion vector when a lower layer frame having the same temporal position as a current layer frame is not present.

According to an aspect of the present invention, there is provided a method for efficiently encoding multi-layered motion vectors, including: obtaining a motion vector in a mother frame of a base layer that is temporally closest to an unsynchronized frame of a current layer; obtaining a predicted motion vector from the motion vector in the mother frame considering the referencing direction in the mother frame and in the unsynchronized frame and distances between the mother frame and a reference frame and between the unsynchronized frame and a reference frame; generating a residual between the motion vector in the unsynchronized frame and the predicted motion vector; and encoding the motion vector in the mother frame and the residual.

### BRIEF DESCRIPTION OF THE DRAWINGS

The above and/or other aspects of the present invention will become more apparent by describing in detail exemplary embodiments thereof with reference to the attached drawings in which:

FIG. 1 shows an example of a scalable video codec using a multi-layered structure;

FIG. 2 is a diagram for explaining a method for efficiently representing a motion vector using motion prediction;

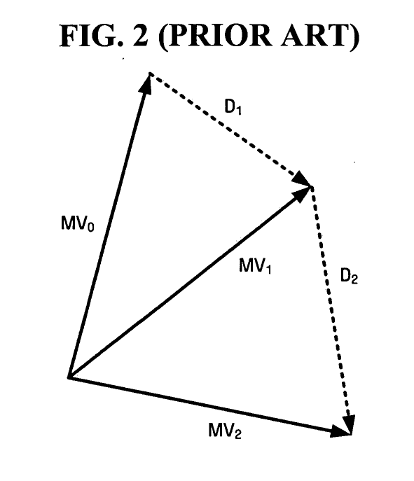

FIG. 3 is a schematic diagram for explaining a fundamental concept of vector base-layer motion according to the present invention;

FIG. 4 is a diagram for explaining the detailed operation of VBM according to the present invention;

FIG. 5A is a schematic diagram showing an example in which bi-directional prediction is applied;

FIG. 5B is a schematic diagram showing an example in which backward prediction is applied;

FIG. 5C is a schematic diagram showing an example in which forward prediction is applied;

FIG. 6 shows an example in which a sub-macroblock pattern in a mother frame corresponding to a sub-macroblock in an unsynchronized frame is further divided into sections;

FIG. 7 shows an example in which a sub-macroblock pattern in an unsynchronized frame is further divided into sections;

FIG. 8 shows an example of obtaining a pixel-based virtual motion vector;

FIG. 9 is a block diagram of a video encoder according to an exemplary embodiment of the present invention; and

FIG. 10 is a block diagram of a video decoder according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention proposes a new method for improving interlayer motion prediction. The main purpose of the present invention is to provide a method for effectively predicting a motion field of a frame having no corresponding base layer frame. The method may reduce the number of motion bits when the frame rate of a current layer is different than a base layer. This method is based on Scalable Video Model 3.0 of ISO/IEC 21000-13 Scalable Video Coding” (“SVM 3.0”) and includes generating a virtual motion vector using adjacent base layer frames and calculating a predicted motion vector using virtual base-layer motion (VBM).

SVM 3.0 is based on an interlayer motion prediction technique that uses correlation between interlayer motion fields. In the interlayer motion prediction, the interlayer motion fields can be represented by refining or using a base layer motion as it is. It is known that the interlayer motion prediction is more efficient when the motion fields of two different layers are significantly similar to each other. When two layers have different frame rates, there may be no corresponding base layer frame for a frame. However, in this case, currently available SVM 3.0 uses independent motion prediction and quantization instead of interlayer motion prediction.

The present invention proposes a method of using a base layer motion for multi-layered scalable video coding. In particular, when a current layer has a different frame rate than a base layer, a virtual motion vector in a missing layer frame is produced using motion vectors in adjacent base layer frames. The virtual motion vector may be used for predicting a motion field of a current layer. The motion field of the current layer may be replaced by the virtual motion vector or refined at a predetermined accuracy (e.g., ¼ pixel accuracy). This technique uses correlation between two interlayer motion fields to efficiently reduce the total number of motion bits, which is hereinafter called “virtual base-layer motion” (VBM).

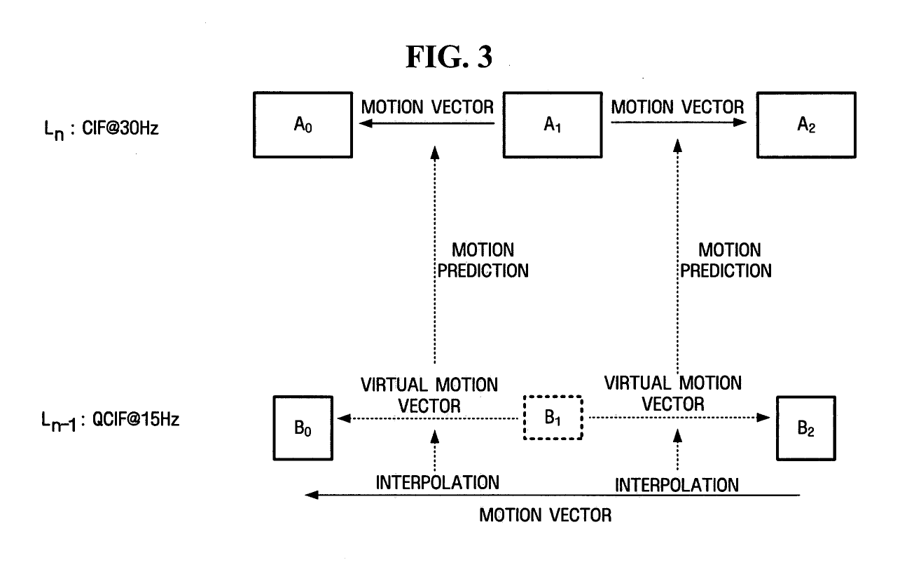

FIG. 3 is a schematic diagram for explaining a fundamental concept of VBM according to the present invention. It is assumed in this example that a current layer Lₙ has CIF resolution and frame rate of 30 Hz and a lower layer Lₙ₋₁ has QCIF resolution and frame rate of 15 Hz.

In the present invention, when there is a base layer frame having the same temporal position as a frame in a current layer, a predicted motion vector is generated using a motion vector in the base layer frame as a reference. On the other hand, when there is no base layer frame corresponding to the current layer frame, a predicted motion vector is generated using motion vectors in at least one of N base layer frames (where N is an integer greater than 1) located closest to the temporal position. Referring to FIG. 3, motion vectors in current layer frames A₀ and A₂ are respectively predicted from motion vectors in lower layer frames B₀ and B₂ having the same temporal positions as the current layer frames A₀ and A₂. Here, motion estimation has substantially the same meaning as that of estimation motion vector generation.

On the other hand, a predicted motion vector for a frame A₁ having no corresponding lower layer frame at the same temporal position is generated using motion vectors in the frames B₀ and B₂ closest to the temporal position. To achieve this, motion vectors in the frames B₀ and B₂ are interposed to generate a virtual motion vector (a motion vector in a virtual frame B₁) at the same temporal position as the frame A₁ and the virtual motion vector is used to predict a motion vector for the frame A₁.

The concept of the VBM may also apply to a motion prediction method that can be used when a current layer has an independent Motion-Compensated Temporal Filtering (MCTF) structure. Assuming that a current layer has an MCTF structure and closed loop processing is performed during MCTF due to a low delay constraint, an MCTF process may be performed in a bottom-up manner, i.e., from coarse to fine temporal levels. In this case, a method similar to that shown in FIG. 3 may be used to predict a motion in an upper fine temporal level from a motion in a lower coarse temporal level.

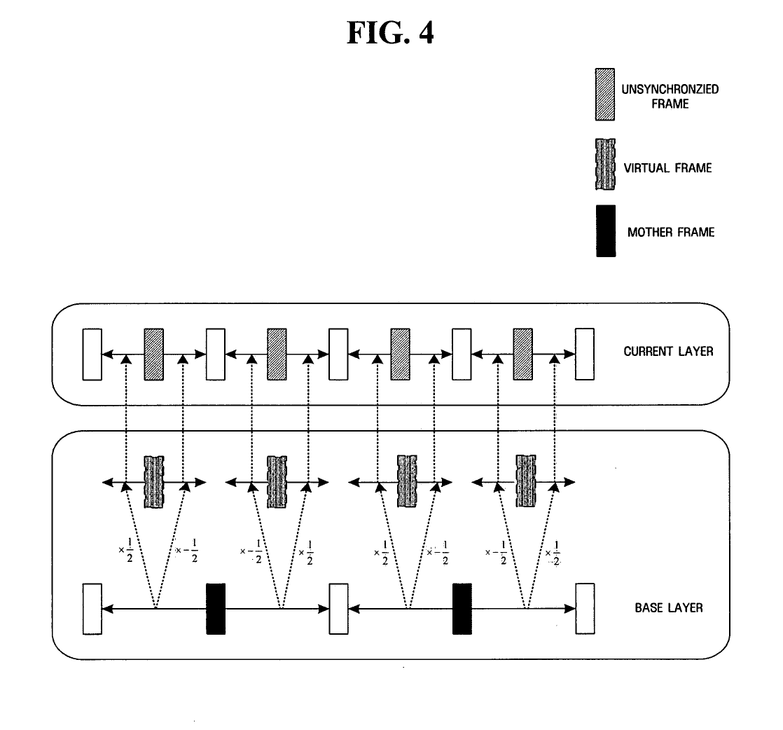

FIG. 4 is a diagram for explaining the detailed operation of VBM according to the present invention.

The basic idea of VBM is to use a strong correlation between motion fields of a current layer and a base layer. A current layer frame having no corresponding base layer frame is termed an “unsynchronized frame” while a current layer frame having a corresponding base layer frame is termed a “synchronized frame”. Because there is no corresponding base layer frame for an unsynchronized frame, a virtual motion vector is used for predicting the unsynchronized frame according to the present invention.

For convenience of explanation, it is assumed that a current layer has double the frame rate of a base layer. To generate the virtual motion vector, a previously encoded base layer motion field is used. The virtual motion vector may be used as a motion vector in an unsynchronized frame of the current layer. Alternatively, the motion vector in the unsynchronized frame is separately obtained and the virtual motion vector is used to efficiently predict the motion vector in the unsynchronized frame. In the latter case, the accuracy of motion vector is higher at the base layer than at the current layer. For example, motion vectors in the base layer may be determined with 1 pixel accuracy and motion vectors in the current layer may be refined to ½ pixel accuracy.

As shown in FIG. 4, a motion vector in a virtual frame, i.e., a virtual motion vector is determined by dividing a motion vector in an adjacent base layer frame by 2. When the direction of referencing in the unsynchronized frame is opposite to that in the base layer mother frame, the virtual motion vector is determined by dividing the motion vector in the adjacent base layer frame by 2 and adding a negative sign to the result. To generalize the idea, the virtual motion vector is determined by multiplying the motion vector in the mother frame by the result obtained by dividing a distance (temporal distance) between the unsynchronized frame and a reference frame by a distance between the mother frame and a reference frame. When the direction of referencing (forward or backward direction) in the unsynchronized frame is opposite to that in the mother frame, the virtual motion vector is determined by adding a negative sign to the product.

A macroblock mode for each macroblock in the virtual frame (“virtual macroblock mode”) is decided in the same way as a macroblock mode in a base layer mother frame. Here, the mother frame refers to a frame with a closest temporal distance from the unsynchronized frame (one frame if there are two closest frames). When the base layer has a different resolution than the current layer, the virtual macroblock mode and the virtual motion vector should be appropriately upsampled.

While FIG. 4 shows that bi-directional prediction is used for inter-prediction, forward prediction from a temporally previous frame or backward prediction from a temporally subsequent frame may also be used.

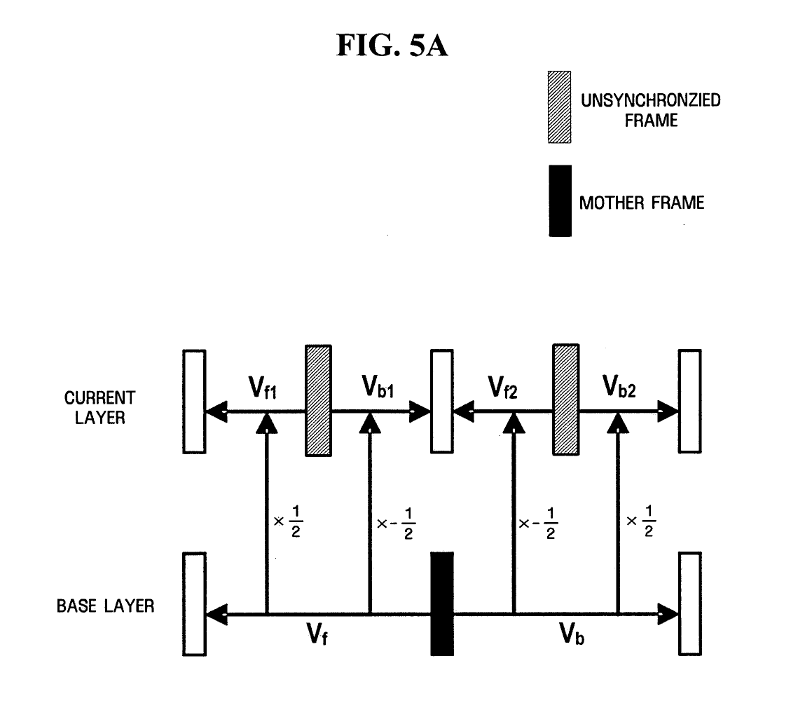

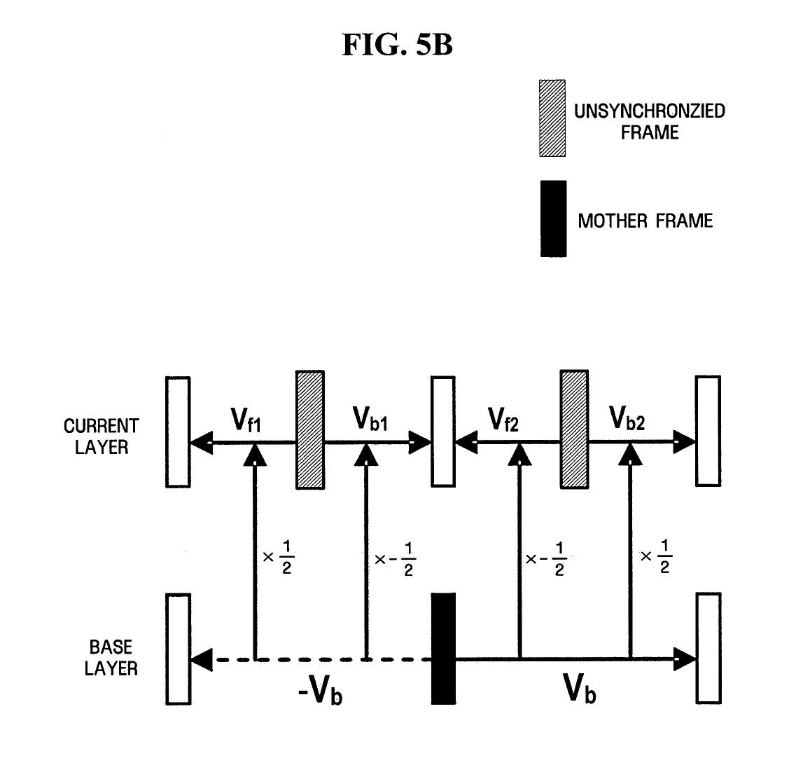

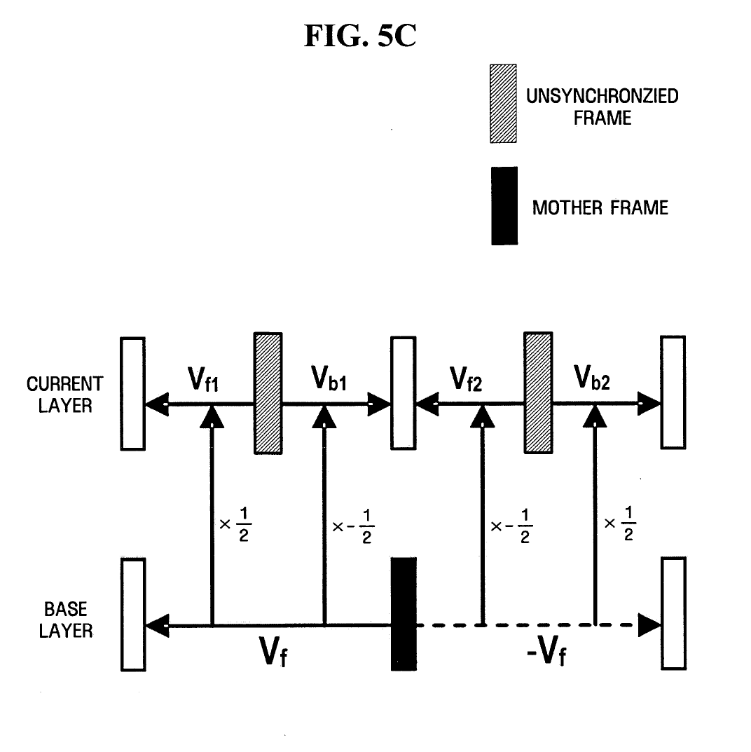

FIGS. 5A through 5C respectively show examples for generating virtual motion vectors using bi-directional, backward, and forward prediction methods.

Referring to FIG. 5A, a forward motion vector V_{f} in a base layer mother frame is used to calculate motion vectors V_{f1} and V_{b1} in an unsynchronized frame. A backward motion vector V_{b} in the mother frame is used to calculate motion vectors V_{f2} and V_{b2} in an unsynchronized frame. When a current layer has double the frame rate of a base layer, the motion vectors V_{f1}, V_{b1}, V_{f2}, and V_{b2} are defined by Equation (1):
V_{f1}≈1/2×Vf
V_{b1}≈½×Vf
V_{f2}≈−½×Vb
V_{b2}≈½×Vb (1)

However, bi-directional prediction is not necessarily used for both the base layer and the current layer. That is, when only forward or backward prediction is performed for the current layer, only a part of Equation (1) may be used.

A sign “≈” in the Equation (1) means that a specific motion vector in the current layer approximates a virtual motion vector on the right-hand side of the Equation (1). That is, the virtual motion vector on the right may be used as the current layer motion vector, which means the sign is an equality sign. The virtual motion vector may also be used to predict the current layer motion vector, which means the virtual motion vector is used as a predictor for the current layer motion vector. Throughout this specification, the sign “≈” has the same meaning as defined above.

FIGS. 5B and 5C illustrate examples in which one-directional and bi-directional predictions are respectively performed for a base layer and a current layer. Referring to FIG. 5B, backward prediction is performed in the base layer. A backward motion vector V_{b} in a base layer mother frame is used to calculate motion vectors V_{f2} and V_{b2} in an unsynchronized frame. In this case, because there is no forward motion vector in the mother frame, motion vectors V_{f1} and V_{b1} are obtained using the backward motion vector V_{b} with a negative sign, i.e., −V_{b}. Thus, assuming that the current layer has double the frame rate of the base layer, the motion vectors V_{f1}, V_{b1}, V_{f2}, and V_{b2} are defined by Equation (2):
V_{f1}≈− ½×V_{b}
V_{b1}≈ ½×V_{b}
V_{f2}≈− ½×V_{b}
V_{b2}≈ ½×V_{b} (2)

Referring to FIG. 5C, forward prediction is performed in the base layer. A forward motion vector V_{f} in a base layer mother frame is used to calculate motion vectors V_{f1} and V_{b1} in an unsynchronized frame. In this case, because there is no backward motion vector in the mother frame, motion vectors V_{f2} and V_{b2} are obtained using the forward motion vector V_{f} with a negative sign, i.e., −V_{f}. Thus, assuming that the current layer has double the frame rate of the base layer, the motion vectors V_{f1}, V_{b1}, V_{f2}, and V_{b2} are given by Equation (3):
V_{f1}≈½×V_{f}
V_{b1}≈−½×V_{f}
V_{f2}≈½×V_{f}
V_{b2}≈−½×V_{f} (3)

Of course, while it is assumed above that the current layer has double the frame rate of the base layer, “ratio of temporal referencing distance” between layers may be other than ½ in the Equations (1) through (3). To clarify the term used herein, a predicted motion vector is defined as a frame that will be replaced by a motion vector in an unsynchronized frame or used for predicting the motion vector in the unsynchronized frame (obtaining a residual between the motion vector in the unsynchronized frame and the predicted motion vector). The predicted motion vector may be a virtual motion vector or another motion vector derived from the virtual motion vector.

Three exemplary embodiments will now be proposed to realize the basic concept of the present invention. In a first exemplary embodiment, the virtual motion vectors obtained by the above Equations (1) through (3) and a sub-macroblock pattern in a mother frame are used in a current layer frame. In a second exemplary embodiment, a sub-macroblock pattern in an unsynchronized frame is determined by a Rate-Distortion (R-D) optimization instead of using a sub-macroblock pattern in a mother frame. In a third exemplary embodiment, a pixel-based predicted motion vector is estimated. The first through third exemplary embodiments will now be described in more detail.

### First Exemplary Embodiment

A virtual motion vector is used as a motion vector in an unsynchronized frame of a current layer. When a motion vector in the unsynchronized frame has the same direction as a motion vector in a mother frame as shown in the Equations (1) through (3), the virtual motion vector is obtained by multiplying the motion vector in the mother frame by the ratio of temporal referencing distance between layers (e.g., ½). When the motion vector in the unsynchronized frame has an opposite direction to the motion vector in the mother frame, the virtual motion vector is obtained by multiplying the power by −1.

Furthermore, since sub-macroblock patterns in an unsynchronized high-pass virtual frame of the current layer are the same as those in the mother frame, a motion vector in the unsynchronized frame is predicted using sub-macroblock patterns in the mother frame. Thus, motion vector search and R-D optimization for selecting a sub-macroblock pattern are not performed for the unsynchronized frame.

### Second Exemplary Embodiment

In the second exemplary embodiment, sub-macroblock patterns in an unsynchronized frame and a mother frame are determined by a separate R-D optimization process. While a virtual motion vector is derived from the mother frame after completing the R-D optimization, the sub-macroblock patterns in the mother frame are different from those in the unsynchronized frame. When the sub-macroblock patterns are different, a motion vector from a sub-macroblock in the unsynchronized frame can be induced from a virtual motion vector overlapped by the sub-macroblock pattern in the unsynchronized frame. To achieve this, the present invention uses the weighted average of the areas of overlapped regions.

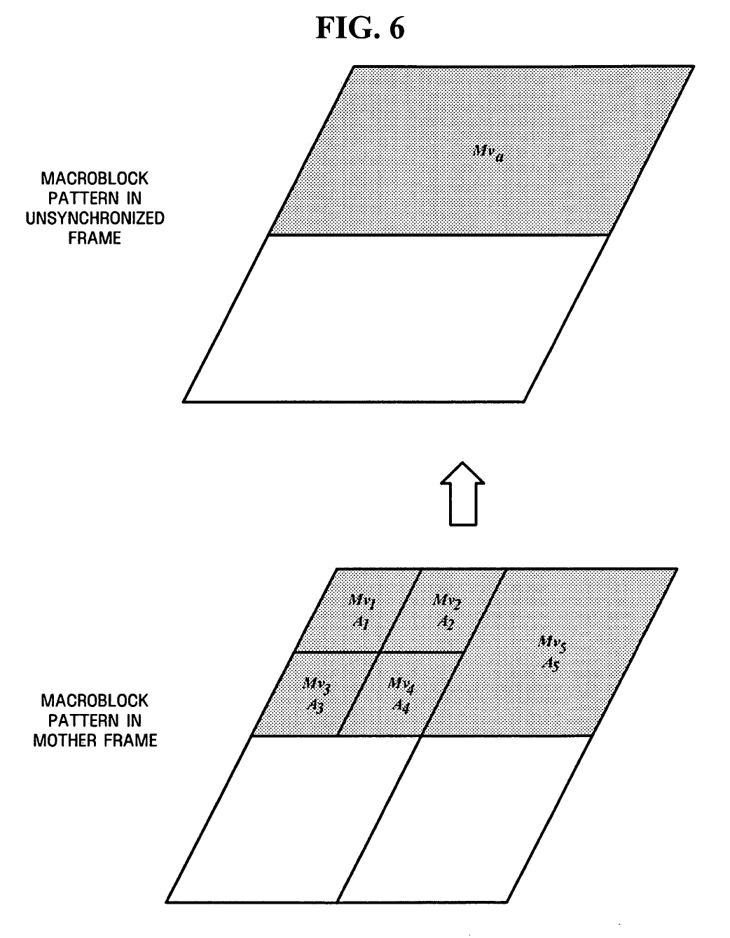

FIG. 6 shows an example in which a sub-macroblock pattern in a mother frame corresponding to a sub-macroblock in an unsynchronized frame is further divided into sections. Here, Mvᵢ and Aᵢ respectively denote a virtual motion vector obtained as defined by the Equations (1) through (3) and the area of a specific sub-macroblock. A motion vector Mvₐ in an unsynchronized frame is replaced or predicted by a predicted motion vector derived as shown in Equation (4) below by weighted averaging the virtual motion vectors Mvᵢ.

$${Mv}_{a} \approx \frac{\begin{matrix}Total sum of Overlapped region \times \\ Motion vector of Overlapped region\end{matrix}}{Total sum of overlapped regions} = \frac{{\sum }_{i} ( {A}_{i} \times {Mv}_{i} )}{{\sum }_{i} {A}_{i}} \qquad ( 4 )$$

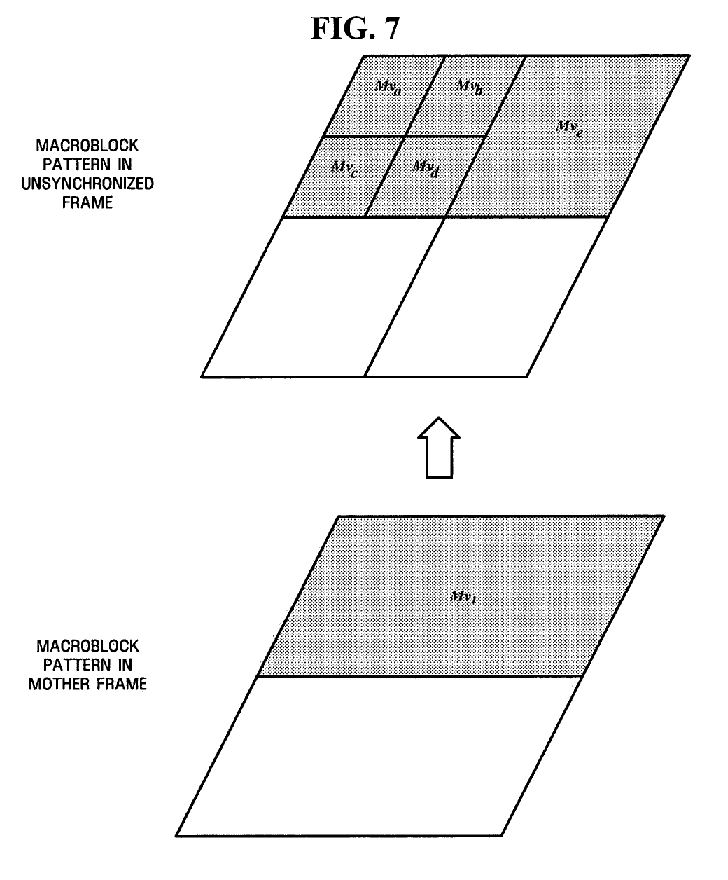

On the other hand, when a sub-macroblock pattern in an unsynchronized frame corresponding to a sub-macroblock in a mother frame is further divided into sections as shown in FIG. 7, motion vectors Mvₐ through Mvₑ in the unsynchronized frame may be all replaced or predicted by a single virtual motion vector MV₁.

### Third Exemplary Embodiment

The third exemplary embodiment focuses on each pixel of a virtual frame. First, a check is made as to all motion vectors passing through a pixel of the virtual frame. A virtual base motion vector for one pixel (“pixel motion vector”) is estimated by a distance-weighted average (distance between centers of the pixel and sub-macroblock). Various distance measures such as Euclidean distance or City Block distance may be used for distance estimation.

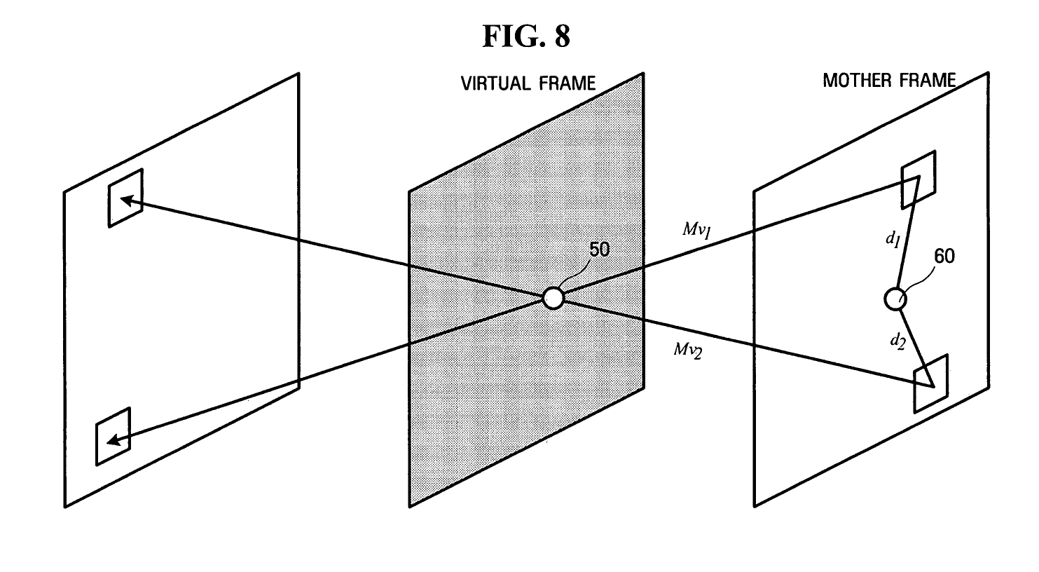

A sub-macroblock pattern in an unsynchronized frame is decided by an R-D optimization process. When a motion vector in the unsynchronized frame is replaced by a virtual motion vector, virtual base motion vectors for the sub-macroblock are estimated using all pixel motion vectors within the same sub-macroblock in the virtual frame. FIG. 8 illustrates a method for estimating virtual base motion vectors.

A motion vector for a pixel of interest 50 in a virtual frame is derived from motion vectors passing through the pixel. A pixel-based virtual motion vector is estimated using Equation (5):

$${Mv}_{pixel} = \frac{{\sum }_{i} \frac{{Mv}_{i}}{{d}_{i}^{2}}}{{\sum }_{i} \frac{1}{{d}_{i}^{2}}} \qquad ( 5 )$$

where Mvₚᵢₓₑₗ, Mvᵢ, and dᵢ respectively denote a pixel motion vector, a motion vector passing through the pixel of interest 50 in the virtual frame, and a distance between a pixel 60 at the same position as the pixel of interest 50 in the mother frame and the center of a sub-macroblock associated with the motion vector Mvᵢ.

A motion vector in an unsynchronized frame is replaced or predicted by a motion vector MVₐ averaged by dividing the sum of all pixel motion vectors within a sub-macroblock of the unsynchronized frame by the number of all of the pixel motion vectors as defined in Equation (6) below. All of the pixel motion vectors are averaged and the averaged motion vector Mvₐ can be used as the motion vector in the unsynchronized frame or as a predictor for the motion vector.

$${Mv}_{a} \approx \frac{{\sum }_{pixel} {Mv}_{pixel}}{Number of pixel motion vectors in sub \text{-} macroblock} \qquad ( 6 )$$

The above-described methods according to the first through third exemplary embodiments and a conventional technique for independently encoding a motion vector in an unsynchronized frame without reference to a base layer can be selected adaptively for efficient coding. For example, R-D costs are calculated for the conventional technique and the exemplary embodiments of the present invention to choose a coding mode that offers smaller R-D costs. The selection can be made at the macroblock level. In this case, some macroblocks may be predicted using virtual motion vectors and others are predicted independently using actual motion vectors.

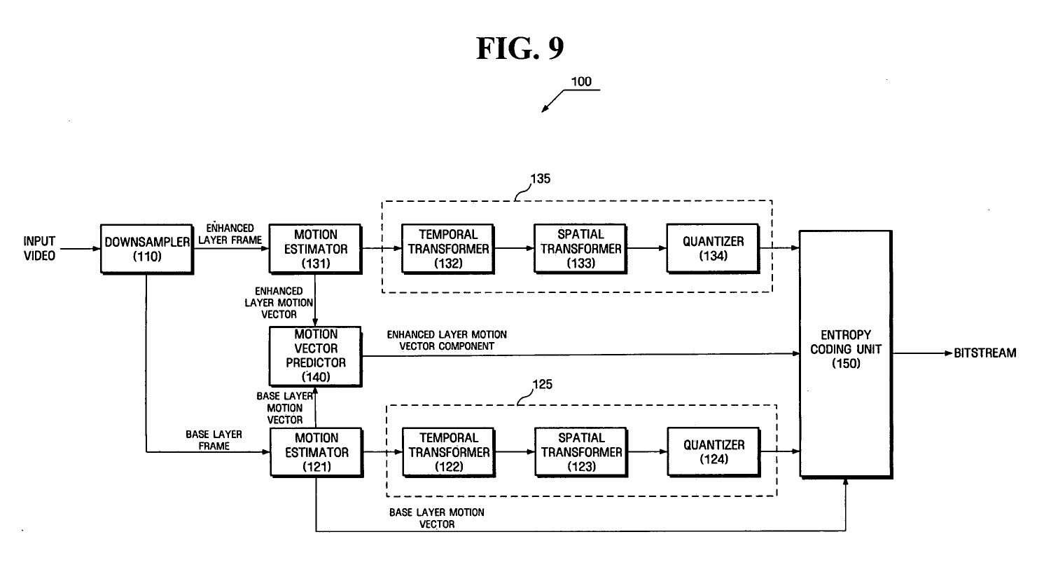

FIG. 9 is a block diagram of a video encoder 100 according to an exemplary embodiment of the present invention. While FIG. 9 shows the use of one base layer and one enhanced layer, it will be readily apparent to those skilled in the art that the present invention can be applied between a lower layer and an upper layer when two or more layers are used.

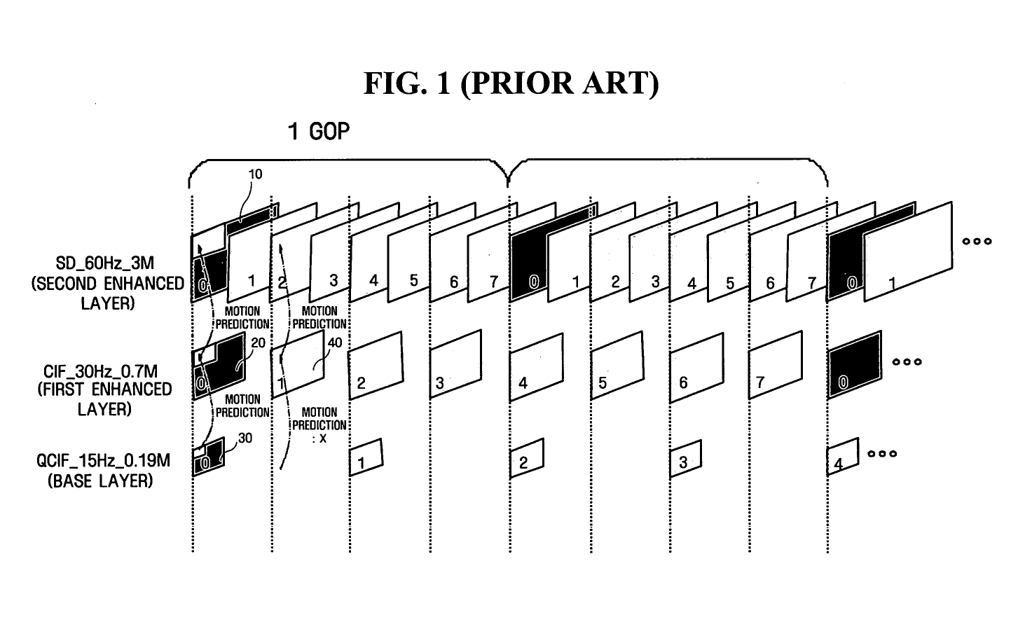

Referring to FIG. 9, a downsampler 110 downsamples an input video to a resolution and frame rate suitable for each layer. When a base layer, having a QCIF resolution and a frame rate of 15 Hz, and an enhanced layer, having a CIF and a frame rate of 30 Hz, are used as shown in FIG. 1, an original input video is downsampled to CIF and QCIF resolutions and then downsampled to frame rates of 15 Hz and 30 Hz. Downsampling the resolution may be performed using an MPEG downsampler or wavelet downsampler. Downsampling the frame rate may be performed using frame skip or frame interpolation. A motion estimator 121 performs motion estimation on a base layer frame to obtain motion vectors of the base layer frame. The motion estimation is the process of finding the closest block to a block in a current frame, i.e., a block with a minimum error. Various techniques including fixed-size block matching and hierarchical variable size block matching (HVSBM) may be used in the motion estimation.

In the same manner, the motion estimator 131 performs motion estimation on an enhanced layer frame to obtain motion vectors of the enhanced layer frame. The motion vectors of the base layer frame and the enhanced layer frame are obtained in this way to predict a motion vector in the enhanced layer frame using a virtual motion vector. When the virtual motion vector is used as the motion vector in the enhanced layer frame, the motion estimator 131 for the enhanced layer may be omitted.

A motion vector predictor 140 uses a motion vector in the base layer frame that is a mother frame to generate a predicted motion vector and uses the predicted motion vector to predict a motion vector in an unsynchronized frame among the enhanced layer frames. The prediction refers to obtaining a residual between the motion vector in the unsynchronized frame and the virtual motion vector. Of course, the predicted motion vector may be used as the motion vector in the unsynchronized frame. Since the method of generating the virtual motion vector has been described earlier, a description thereof will not be given.

The motion vector predictor 140 sends the residual that is an enhanced layer motion vector component to an entropy coding unit 150. When the virtual motion vector is used as the motion vector in the unsynchronized frame without being subjected to motion prediction, the enhanced layer motion vector component need not be generated because it can be derived from the base layer motion vector.

A lossy coding unit 125 performs lossy coding on the base layer frame using the base layer motion vectors received from the motion estimator 121. The lossy coding unit 125 includes a temporal transformer 122, a spatial transformer 123, and a quantizer 124.

The temporal transformer 122 uses the motion vectors obtained by the motion estimator 121 and a frame at a temporally different position than the current frame to generate a predicted frame and subtracts the predicted frame from the current frame to generate a residual frame, thereby removing temporal redundancy. While all macroblocks in a frame are inter macroblocks generated by temporal transform, it will be readily apparent to those skilled in the art that the frame can be made up of a combination of inter macroblocks and intra macroblocks defined in H.264 or intra-BL macroblocks defined in SVM 3.0. Because the main feature of the present invention lies in temporal prediction, the present invention will be described focusing on the temporal transform. The temporal transform may be performed using a hierarchical method considering temporal scalability such as Motion Compensation Temporal filtering (MCTF) or Hierarchical-B or a typical non-hierarchical method such as I, B, and P coding in an MPEG-based codec.

The spatial transformer 123 performs spatial transform on the residual frame generated by the temporal transformer 122 or the original input frame to create a transform coefficient. Discrete Cosine Transform (DCT) or wavelet transform technique may be used for the spatial transform. A DCT coefficient is created when DCT is used for spatial transform while a wavelet coefficient is produced when wavelet transform is used.

The quantizer 124 performs quantization on the transform coefficient obtained by the spatial transformer 123. Quantization is the process of converting real-numbered DCT coefficients into discrete values by dividing the range of coefficients into a limited number of intervals and mapping the real-numbered coefficients into quantization indices according to a predetermined quantization table.

On the other hand, a lossy coding unit 135 performs lossy coding on the enhanced layer frame using motion vectors in the enhanced layer frame obtained by the motion estimator 131. The lossy coding unit 135 includes a temporal transformer 132, a spatial transformer 133, and a quantizer 134. Because the lossy coding unit 135 performs the same operation as the lossy coding unit 125, except that it performs lossy coding on the enhanced layer frame, a detailed explanation thereof will not be given.

The entropy coding unit 150 losslessly encodes (or entropy encodes) the quantization coefficients obtained by the quantizers 124 and 134 for the base layer and the enhanced layer, the base layer motion vectors generated by the motion estimator 121 for the base layer, and the enhanced layer motion vector components generated by the motion vector predictor 140 into an output bitstream.

While FIG. 9 shows the lossy coding unit 125 for the base layer is separated from the lossy coding unit 135 for the enhanced layer, it will be obvious to those skilled in the art that a single lossy coding unit can be used to process both the base layer and the enhanced layer.

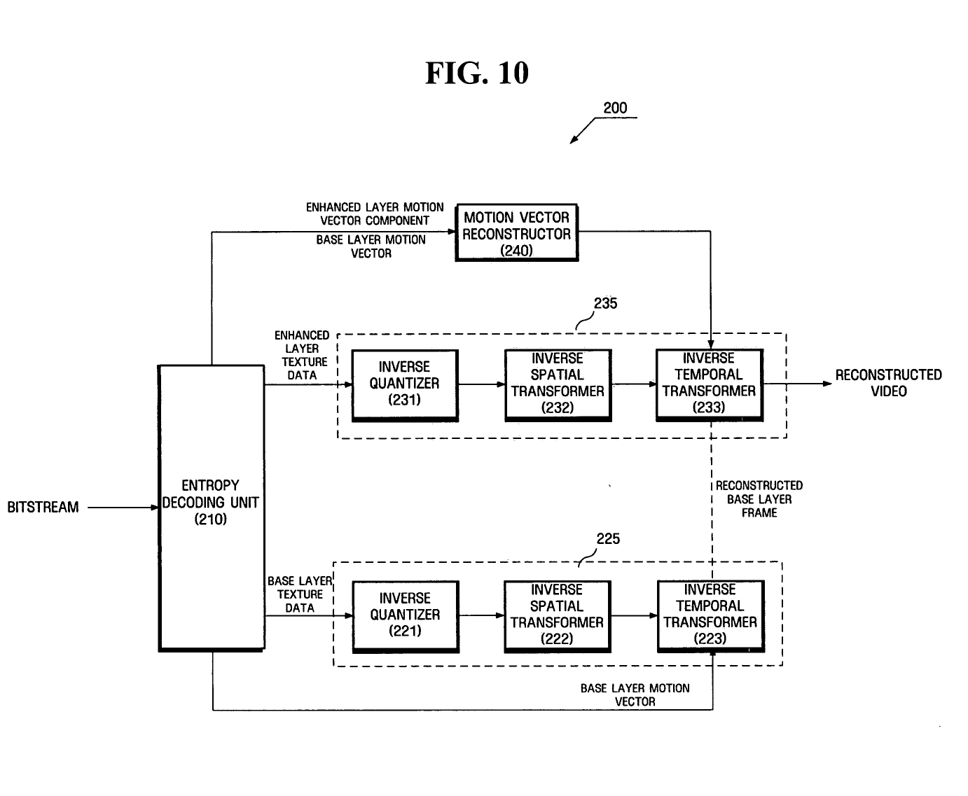

FIG. 10 is a block diagram of a video decoder 200 according to an exemplary embodiment of the present invention.

Referring to FIG. 10, an entropy decoding unit 210 performs the inverse of entropy encoding and extracts motion vectors of a base layer frame, motion vector components of an enhanced layer frame, and texture data from the base layer frame and the enhanced layer frame from an input bitstream.

A motion vector reconstructor 240 calculates a predicted motion vector from the base layer motion vector and adds the predicted motion vector to the enhanced layer motion vector component in order to reconstruct a motion vector in the enhanced layer frame. Since the process of generating the predicted motion vector is performed in the same manner as at the video encoder 100, a detailed explanation thereof will not be given. Reconstructing the motion vector in the enhanced layer frame corresponds to predicting a motion vector in an unsynchronized frame using a predicted motion vector at the video encoder 100. Thus, when the video encoder 100 uses the predicted motion vector as the motion vector in the unsynchronized frame, the enhanced layer motion vector component is not present but the predicted motion vector will be used as a motion vector in a current unsynchronized frame.

A lossy decoding unit 235 performs the inverse operation of the lossy coding unit (135 of FIG. 9) to reconstruct a video sequence from the texture data of the enhanced layer frames using the reconstructed motion vectors in the enhanced layer frames. The lossy decoding unit 235 includes an inverse quantizer 231, an inverse spatial transformer 232, and an inverse temporal transformer 233.

The inverse quantizer 231 performs inverse quantization on the extracted texture data from the enhanced layer frames. The inverse quantization is the process of reconstructing values from corresponding quantization indices created during a quantization process using a quantization table used during the quantization process.

The inverse spatial transformer 232 performs inverse spatial transform on the inversely quantized result. The inverse spatial transform is the inverse of spatial transform performed by the spatial transformer 133 in the encoder 100. Inverse DCT and inverse wavelet transform technique may be used for the inverse spatial transform.

The inverse temporal transformer 233 performs the inverse operation to the temporal transformer 132 on the inversely spatially transformed result to reconstruct a video sequence. More specifically, the inverse temporal transformer 233 uses motion vectors reconstructed by the motion vector reconstructor 240 to generate a predicted frame and adds the predicted frame to the inversely spatially transformed result in order to reconstruct a video sequence.

The encoder 100 may remove redundancies in the texture of an enhanced layer using a base layer during encoding. In this case, because the decoder 200 reconstructs a base layer frame and uses the reconstructed base layer frame and the texture data in the enhanced layer frame received from the entropy decoding unit 210 to reconstruct the enhanced layer frame, a lossy decoding unit 225 for the base layer is used.

In this case, the inverse temporal transformer 233 uses the reconstructed motion vectors of enhanced layer frames to reconstruct a video sequence from the texture data in the enhanced layer frames (inversely spatially transformed result) and the reconstructed base layer frames.

While FIG. 10 shows the lossy decoding unit 225 for the base layer is separated from the lossy decoding unit 335 for the enhanced layer, it will be obvious to those skilled in the art that a single lossy decoding unit can be used to process both the base layer and the enhanced layer.

Each of various components illustrated in FIGS. 9 and 10 means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they are executed one or more computers in a communication system.

According to the present invention, the compression efficiency of multi-layered motion vectors can be improved.

In addition, the quality of an image per a bit rate can be enhanced.

In concluding the detailed description, those skilled in the art will appreciate that many variations and modifications can be made to the exemplary embodiments without substantially departing from the principles of the present invention. Therefore, the disclosed exemplary embodiments of the invention are used in a generic and descriptive sense only and not for purposes of limitation.

What is claimed is:

1. A method for encoding multi-layered motion vectors, the method comprising:
obtaining a motion vector in a mother frame of a base layer that is temporally closest to an unsynchronized frame of a current layer;
obtaining a predicted motion vector from the motion vector in the mother frame according to a referencing direction and a referencing distance of the mother frame, and a referencing direction and a referencing distance of the unsynchronized frame;
generating a residual between the motion vector in the unsynchronized frame and the predicted motion vector; and
encoding the motion vector in the mother frame and the residual.

2. The method of claim 1, wherein if there are at least two closest base layer frames, the mother frame is a high-pass frame of the at least two closest base layer frames.

3. The method of claim 1, wherein the obtaining the predicted motion vector comprises multiplying the motion vector in the mother frame by a result obtained by dividing a distance between the unsynchronized frame and a reference frame by a distance between the mother frame and the reference frame and adding a negative sign to the product if the referencing direction of the unsynchronized frame is opposite to the referencing direction of the mother frame.

4. The method of claim 1, wherein sub-macroblock patterns in the mother frame are the same as sub-macroblock patterns in the unsynchronized frame.

5. The method of claim 1, wherein a sub-macroblock pattern in the unsynchronized frame is determined by a Rate-Distortion optimization, independently of a sub-macroblock pattern in the mother frame.

6. The method of claim 5, wherein the obtaining the predicted motion vector comprises:
generating a virtual predicted motion vector by multiplying the motion vector in the mother frame by a result obtained by dividing a distance between the unsynchronized frame and a reference frame by a distance between the mother frame and the reference frame and adding a negative sign to the product if the referencing direction of the unsynchronized frame is opposite to the referencing direction of the mother frame; and
generating the predicted motion vector by weighted averaging areas of sub-macroblocks in the mother frame overlapped by sub-macroblock patterns in the unsynchronized frame.

7. The method of claim 6, wherein in the obtaining the predicted motion vector, the predicted motion vector is obtained by
$$\frac{{\sum }_{i} ( {A}_{i} \times {Mv}_{i} )}{{\sum }_{i} {A}_{i}}$$
where Mvᵢ is a virtual motion vector and Ai is an area of a specific sub-macroblock.

8. The method of claim 1, wherein the obtaining the predicted motion vector comprises:
calculating pixel motion vectors within a sub-macroblock of a virtual frame; and
obtaining the predicted motion vector by dividing a sum of the pixel motion vectors by a number of the pixel motion vectors within the sub-macroblock.

9. The method of claim 7, wherein the calculating the pixel motion vectors is performed using
$${Mv}_{pixel} = \frac{{\sum }_{i} \frac{{Mv}_{i}}{{d}_{i}^{2}}}{{\sum }_{i} \frac{1}{{d}_{i}^{2}}}$$
where Mvₚᵢₓₑₗ is a pixel motion vector, Mvᵢ is a motion vector passing through a pixel of interest in a virtual high-pass frame, and dᵢ is a distance between a pixel at a same position as the pixel of interest in the mother frame and a center of a sub-macroblock associated with the motion vector Mvᵢ.

10. A method for encoding multi-layered motion vectors, the method comprising:
obtaining a motion vector in a mother frame of a base layer that is temporally closest to an unsynchronized frame of a current layer;
obtaining a predicted motion vector from the motion vector in the mother frame according to a referencing direction of the mother frame, a referencing direction the unsynchronized frame, a distance between the mother frame and a reference frame and a distance between the unsynchronized frame and the reference frame;
setting the predicted motion vector as a motion vector in the unsynchronized frame; and
encoding the motion vector in the mother frame.

11. The method of claim 10, wherein if there are at least two closest base layer frames, the mother frame is a high-pass frame of the at least two closest base layer frames.

12. The method of claim 10, wherein the obtaining the predicted motion vector comprises multiplying the motion vector in the mother frame by a result obtained by dividing the distance between the unsynchronized frame and the reference frame by the distance between the mother frame and the reference frame and adding a negative sign to the product if the referencing direction of the unsynchronized frame is opposite to the referencing direction of the mother frame.

13. The method of claim 10, wherein sub-macroblock patterns in the mother frame are the same as sub-macroblock patterns in the unsynchronized frame.

14. The method of claim 10, wherein a sub-macroblock pattern in the unsynchronized frame is determined by a Rate-Distortion optimization, independently of a sub-macroblock pattern in the mother frame.

15. The method of claim 14, wherein the obtaining the predicted motion vector comprises:
generating a virtual predicted motion vector by multiplying the motion vector in the mother frame by a result obtained by dividing the distance between the unsynchronized frame and the reference frame by the distance between the mother frame and the reference frame and adding a negative sign to the product if the referencing direction of the unsynchronized frame is opposite to in the referencing direction of the mother frame; and
generating the predicted motion vector by weighted averaging areas of sub-macroblocks in the mother frame overlapped by sub-macroblock patterns in the unsynchronized frame.

16. The method of claim 15, wherein in the obtaining the predicted motion vector, the predicted motion vector is obtained by
$$\frac{{\sum }_{i} ( {A}_{i} \times {Mv}_{i} )}{{\sum }_{i} {A}_{i}}$$
where Mvᵢ is a virtual motion vector and Aᵢ is an area of a specific sub-macroblock.

17. The method of claim 10, wherein the obtaining the predicted motion vector comprises:
calculating pixel motion vectors within a sub-macroblock of a virtual frame; and
obtaining the predicted motion vector by dividing a sum of the pixel motion vectors by a number of the pixel motion vectors within the sub-macroblock.

18. The method of claim 17, wherein the calculating the pixel motion vectors is performed using
$${Mv}_{pixel} = \frac{{\sum }_{i} \frac{{Mv}_{i}}{{d}_{i}^{2}}}{{\sum }_{i} \frac{1}{{d}_{i}^{2}}}$$
where Mvₚᵢₓₑₗ respectively denote a pixel motion vector, Mvᵢ is a motion vector passing through a pixel of interest in a virtual high-pass frame, and dᵢ is a distance between a pixel at a same position as the pixel of interest in the mother frame and a center of a sub-macroblock associated with the motion vector Mvᵢ.

19. An apparatus for efficiently encoding multi-layered motion vectors, the apparatus comprising:
a means for obtaining a motion vector in a mother frame of a base layer that is temporally closest to an unsynchronized frame of a current layer;
a means for obtaining a predicted motion vector from the motion vector in the mother frame according to a referencing direction of the mother frame, a referencing direction of the unsynchronized frame, a distance between the mother frame and a reference frame and a distance between the unsynchronized frame and the reference frame;
a means for generating a residual between the motion vector in the unsynchronized frame and the predicted motion vector; and
a means for encoding the motion vector in the mother frame and the residual.

20. An apparatus for encoding multi-layered motion vectors, the apparatus comprising:
a means for obtaining a motion vector in a mother frame of a base layer that is temporally closest to an unsynchronized frame of a current layer;
a means for obtaining a predicted motion vector from the motion vector in the mother frame according to a referencing direction of the mother frame, a referencing direction of the unsynchronized frame, a distance between the mother frame and a reference frame and a distance between the unsynchronized frame and the reference frame;
a means for setting the predicted motion vector as the motion vector in the unsynchronized frame; and
a means for encoding the motion vector in the mother frame.

21. A recording medium having a computer readable program recorded therein, the program for executing a method for encoding multi-layered motion vectors, the method comprising:
obtaining a motion vector in a mother frame of a base layer that is temporally closest to an unsynchronized frame of a current layer;
obtaining a predicted motion vector from the motion vector in the mother frame according to a referencing direction and a referencing distance of the mother frame, and a referencing direction and a referencing distance of the unsynchronized frame;
generating a residual between the motion vector in the unsynchronized frame and the predicted motion vector; and
encoding the motion vector in the mother frame and the residual.
